(19) United States
(12) Patent Application Publication
(10) Pub. No.: US 2008/0053670 A1
(43) Pub. Date: Mar. 6, 2008

(54) Aerator attachment for mower

(76) Inventors: Donald Lee Jarmer, Baltimore, MD (US); Dale John Jarmer, Baltimore, MD (US); Donald Lee Jarmer, Pasadena, MD (US)

Correspondence Address: WILLIAM S RAMSEY, ESQ, 5253 EVEN STAR PLACE, COLUMBIA, MD, 21044, US

(21) Appl. No.: 11/493,177

(22) Filed: Jul. 26, 2006

(51) Int. Cl. A01B 45/02; A01B 45/00

(52) U.S. Cl. 172/21

(57) ABSTRACT

An exemplary embodiment providing one or more improvements includes a frame which is attached to the front or rear of a lawn mower, and a spike assembly attached to the frame which provides spikes on rotating collars. The spikes penetrate and are withdrawn from the soil when the mower is moved, thereby aerating the soil. Embodiments can be attached to a vertical or horizontal surface on a mower. Guards optionally may protect the user from any injury.

### CROSS-REFERENCE(S)

Not Applicable.

### STATEMENT REGARDING FEDERALLY SPONSORED RESEARCH OR DEVELOPMENT

Not Applicable.

### REFERENCE TO A “MICROFICHE APPENDIX.”

Not Applicable.

### BACKGROUND

This invention relates to a lawn aeration attachment for wheeled lawn husbandry implements.

Aeration is the process of treating soil in order to improve penetration of air into the soil. Benefits from lawn aeration include improvement of exchange of air between the soil and the atmosphere, enhancement of water uptake by the soil, and improvement of nutrients and fertilizer uptake by the grass, thereby improving the grass growth. By allowing penetration of fertilizers and insecticides into the soil, undesirable chemical runoff into surface waters is prevented. In addition, aeration prevents the development of hard spots and erosion of the soil. Grass rooting also is improved by aeration, resulting in enhanced drought and heat tolerance in the lawn. In addition, aeration reduces soil compaction, a common lawn condition. In general, lawn cushioning and resiliency is improved by aeration. Finally, microbial degradation of thatch, the collection of lawn clippings at the soil surface, also is enhanced by aeration. This has the desirable advantage of removing thatch from the lawn.

Aeration of lawns is recommended at least twice annually, in the spring and the fall. Lawns on poor soil will benefit from more frequent treatment.

### DESCRIPTION OF RELATED ART INCLUDING INFORMATION DISCLOSED UNDER 37 CFR 1.97 AND 37 CFR 1.98.

U.S. Pat. No. 2,476,084 discloses an aerator attachment behind a mower which is attached by supporting brackets.

U.S. Pat. No. 3,945,176 discloses a power driven aerator attached to the front of a lawn mower. The power driven aerator is located between the driven wheels of the lawn mower.

U.S. Pat. No. 4,616,714 discloses a hand aerator with spikes mounted on freely rotating sleeves on an axle. The aerator handle has a hitching yoke for attachment to a towing riding mower.

U.S. Pat. No. 4,899,828 discloses an aerator with spikes on a roller which attaches to a mower via support arms or mounting members which may be pivoted to raise the aerator.

U.S. Pat. No. 6,832,657 discloses an aerator attachment for a mower with a hydraulic actuator which raises and lowers the aerator, thereby allowing the weight of the mower to bear on the aerator, insuring penetration of the tubular tines.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

An aerator attachment for a lawn mower comprises a frame comprised of a bracket with means for reversible attachment to the mower and two support arms attached to the bracket. A spike assembly is attached to the frame and comprises an axle extending between the support arms and a multiplicity of sleeves mounted on the axle. A multiplicity of collars is rotatively mounted on the axle, the collars are interspersed between the sleeves, and a multiplicity of spikes are arrayed about the circumference of the collars. Embodiment aerators are demountably attached to either the front or rear of a lawn mower. The mower may be push or powered, and may have freely-rotating or driven wheels. Embodiment aerators are easily attached and removed so the lawn can be simultaneously cut and aerated when lawn aeration is desired, and only mowed when aeration is not desired.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view of one embodiment aerator attachment attached to the front of a lawn mower.

FIG. 2 is a plan view of the first embodiment aerator attachment.

FIG. 3 is a cross-section view taken along line 3-3 of FIG. 2.

FIG. 4 is a perspective view of a first embodiment frame.

FIG. 5 is a perspective view of a second embodiment frame.

FIG. 6 is a perspective view of an optional first embodiment guard.

FIG. 7 is a perspective view of an optional second embodiment guard.

### DETAILED DESCRIPTION

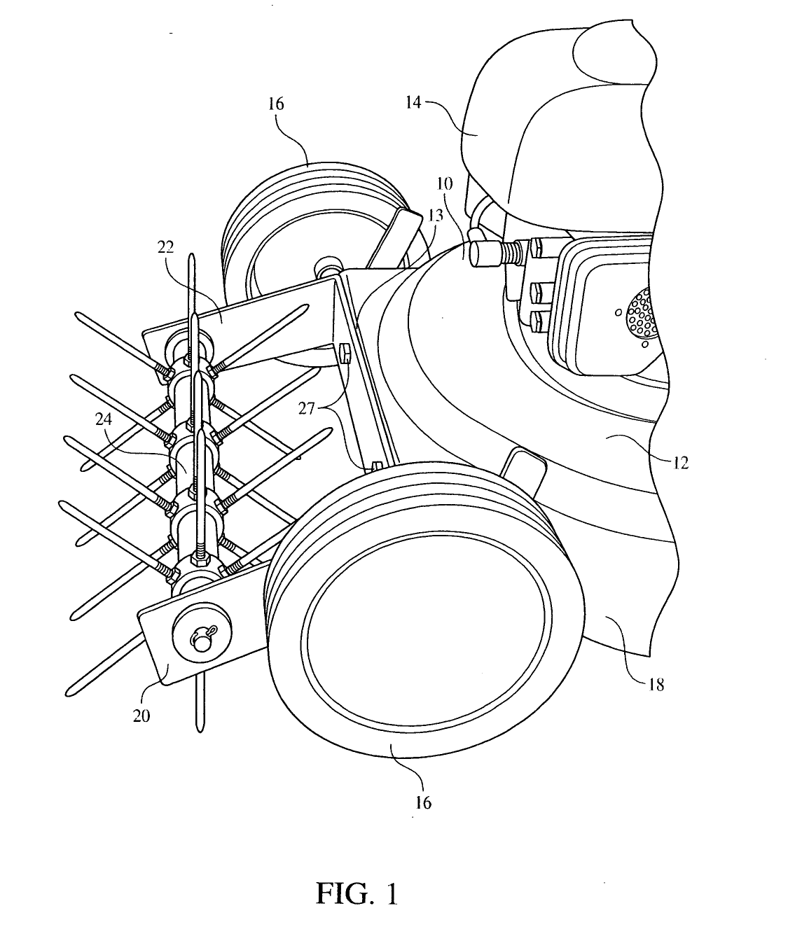

FIG. 1 is a perspective view of a first embodiment aerator attachment attached to the front of a lawn mower. The first embodiment attachment is the same as the second embodiment except the first embodiment attachment includes the first embodiment frame. The second embodiment aerator includes the second embodiment frame. In both the first and second embodiments the same spike assembly is used.

The front end of a lawn mower 10 is partially visible in FIG. 1. Also visible are the front wheels 16 which are attached to the deck 18, and the motor 14 which powers the mower. The first embodiment aerator attachment 20 is attached by the frame 22 to the approximately vertical skirt 13 portion at the front of the deck 18 by bolts 27.

Also visible in FIG. 1 is the spike assembly 24 which is attached to the frame 22.

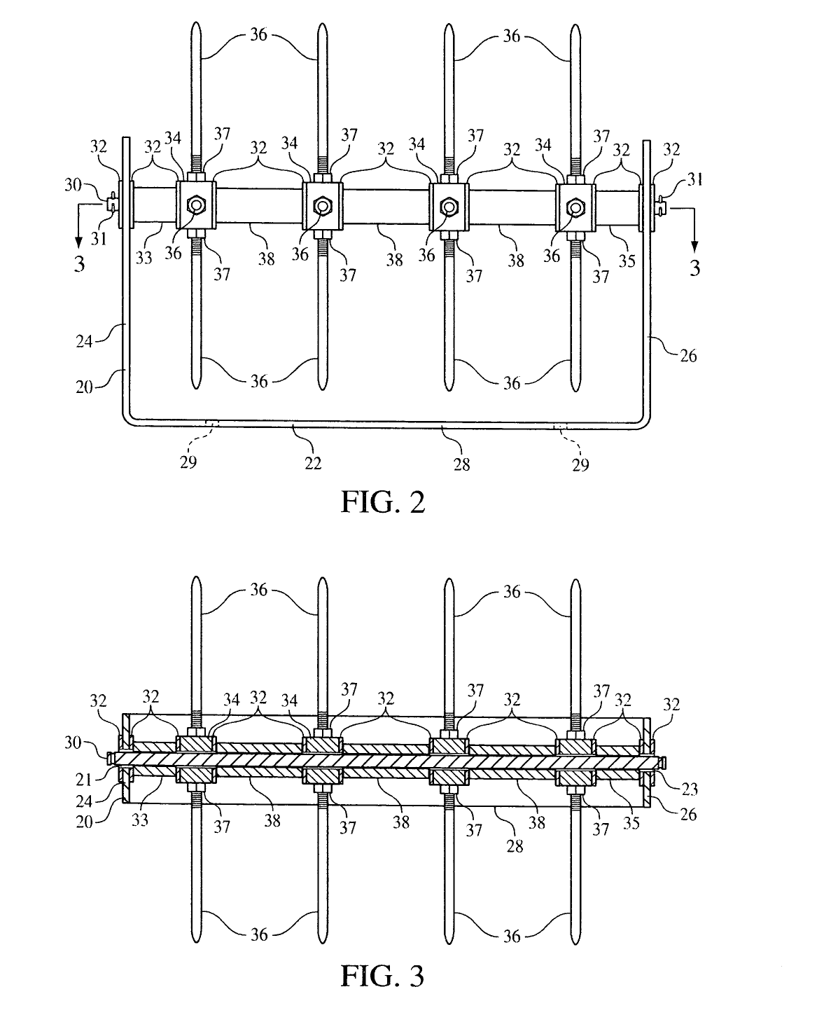

FIG. 2 is a plan view of the first embodiment aerator attachment. The first embodiment frame 22 comprises the bracket 28, left arm 24 and right arm 26. The arms are attached at approximately right angles to the bracket, and may be integral to the bracket. Alternatively, the arms may be welded to the bracket or be attached by other means such as bolts.

The tine assembly comprises an axle 30 which extends through holes in the left 24 and right 26 arms. The axle is secured in the holes in the arms by pins 31 and washers 32. A multiplicity of cylindrical collars 34 are mounted on the axle. Short sleeves 33 and 35 separate collars 34 from the left 24 and right 26 arms, respectively. Long sleeves 38 separate the collars 34 from each other. Washers 32 are mounted on the axle between the collars and sleeves and between the sleeves and arms. Each collar has a multiplicity of spikes arrayed about the circumference of the collar. In some embodiments four to eight spikes are attached to each collar. In some embodiments holes in the circumference of a collar are threaded and threaded spikes are inserted into the holes. Threaded lock nuts 37 are used to secure the spikes 36 in the collars 34. The spikes are long enough to penetrate the soil, thereby aerating the soil.

FIG. 3 is a cross-section view of the first embodiment aerator attachment taken along line 3-3 of FIG. 2. The first embodiment frame 22 comprises the bracket 28, left arm 24 and right arm 26, also visible are the holes 29 for attachment of the frame to the mower.

The tine assembly comprises an axle 30 which extends through holes 21 and 23 in the left 24 and right 26 arms, respectively. The axle is secured in the holes in the arms by pins 31 (not visible in FIG. 3) and washers 32. A multiplicity of cylindrical collars 34 are mounted on the axle. The collars 34 are separated by sleeves 38. Washers 32 are mounted on the axle between the collars and sleeves and between the sleeves and arms. Each collar has a multiplicity of spikes arrayed about the circumference of the collar. In some embodiments holes in the circumference of a collar are threaded and threaded spikes are inserted into the holes. Threaded lock nuts 37 are used to secure the spikes 36 in the collars 34. The spikes are long enough to penetrate the soil, thereby aerating the soil. In embodiments spikes are removable and a variety of different length spikes may be used.

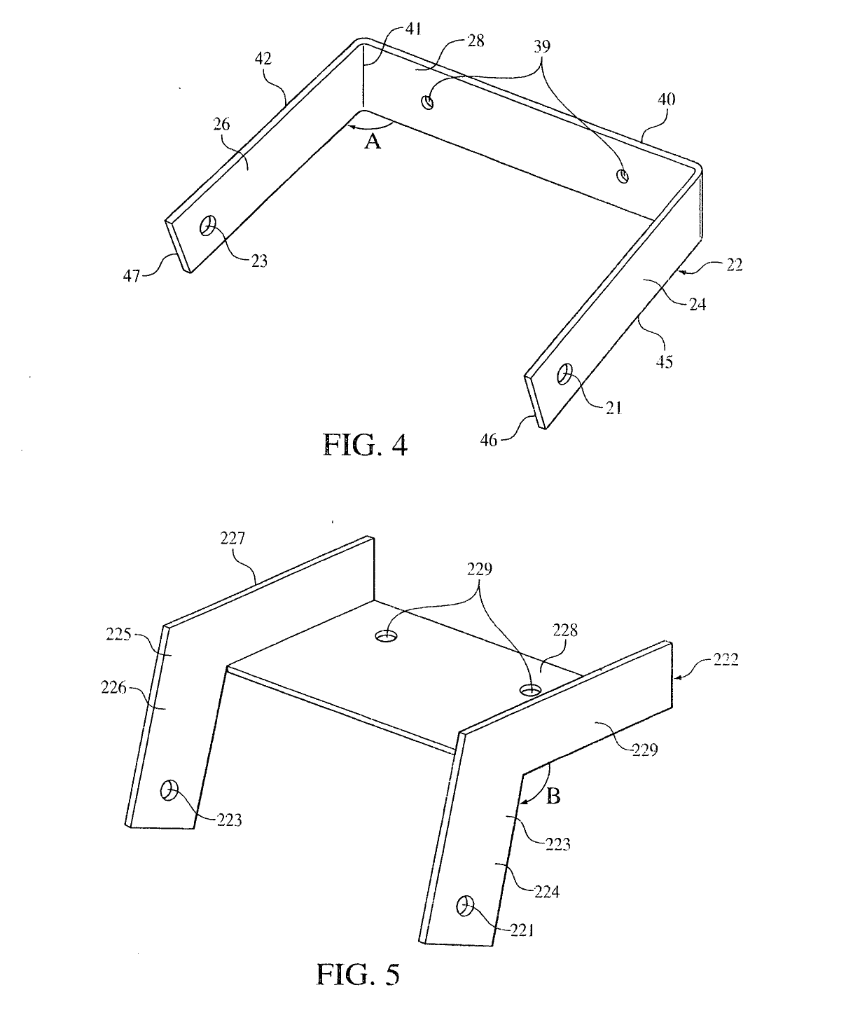

FIG. 4 is a perspective view of a first embodiment frame 22. The first embodiment frame is used when it is desirable to attach the aerator attachment to an approximately vertical portion of a mower deck.

The first embodiment frame 22 comprises the left arm 24 attached to one end of the bracket 28 and the right arm 26 attached to the other end of the bracket 28. The rectangular bracket 28 has a long edge 40 and a short edge 41. Holes 29 in the bracket 28 are used to attach the frame via bolts, screws, clamps, hooks, cables, latches or other suitable fastener means on the mower deck. Left arm 24 has an upper long edge 44 and a lower long edge 45 and an end 46. Right arm 26 has an upper long edge 42, lower long edge 43, and end 47. Holes 21 and 23 are used for attachment of the spike assembly to the left 24 and right 26 arms, respectively. The angle between the plane of the bracket 28 and the long edges of the arms, angle A, is approximately 45°. When attached to a mower, the bracket 28 of the first embodiment frame 22 is approximately vertical.

FIG. 5 is a perspective view of a second embodiment frame. The second embodiment frame is used when it is desirable to attach the aerator attachment to an approximately horizontal portion of a mower deck. Holes 229 in the bracket 228 are used to attach the frame via bolts or other suitable fasteners on the mower deck. The second embodiment frame 222 comprises the left arm 224 attached to one end of the bracket 228 and the right arm 226 attached to the other end of the bracket 228. Holes 221 and 223 are used for attachment of the spike assembly to the left 224 and right 226 arms, respectively. The angle between the plane of the bracket 228 and the long edges of the arms, angle B, is approximately 135°. When attached to a mower, the bracket 228 of the second embodiment frame 222 is approximately horizontal.

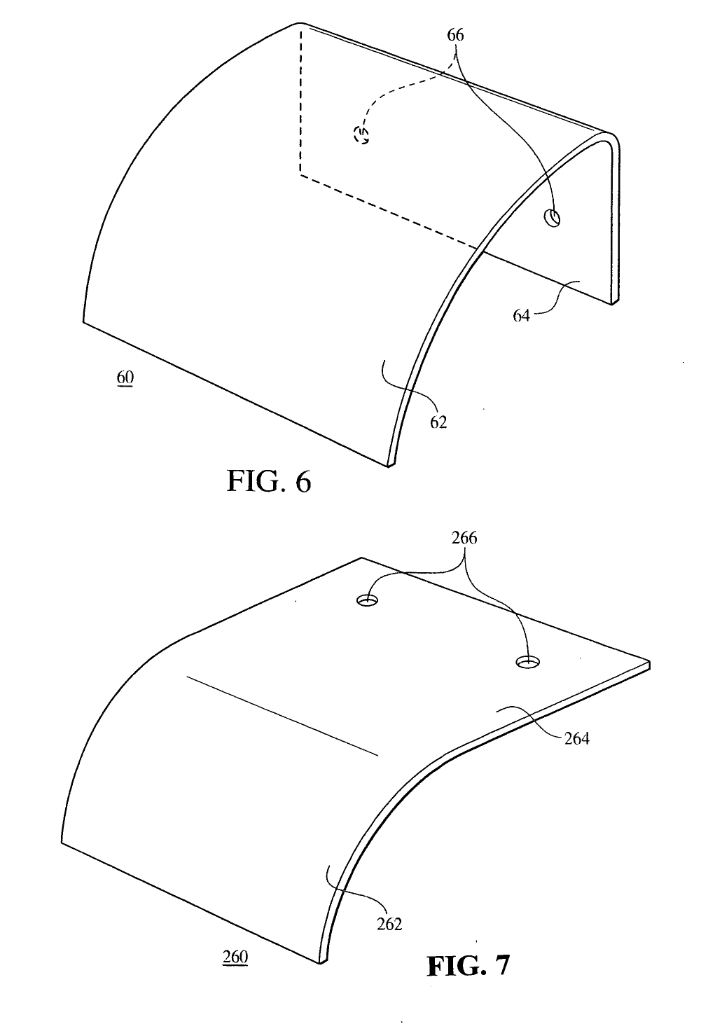

FIG. 6 is a perspective view of an optional first embodiment guard 60. The first embodiment guard is used with the first embodiment frame. The first embodiment guard is comprised of a approximately hemispheric canopy 62 attached to a approximately rectangular flange 64. The plane of the flange is approximately parallel to a radius to the canopy. Holes 66 in the flange are used in connecting the guard to a mower. The guard flange may be attached between the approximately vertical skirt portion of the front or rear of the deck and the aerator bracket or, alternatively, the guard flange may be attached to the front of the bracket. The bolts which secure the bracket to the mower also secure the guard.

FIG. 7 is a perspective view of an optional second embodiment guard 260. The second embodiment guard is used with the second embodiment frame. The second embodiment guard is comprised of a approximately hemispheric canopy 262 attached to a approximately rectangular flange 264. The plane of the flange is approximately tangent to the canopy. Holes 266 in the flange are used in connecting the guard to a mower. The guard flange may be attached between the approximately horizontal skirt portion of the front or rear of the mower deck above the aerator bracket. The bolts which secure the bracket to the mower also secure the guard.

The optional guards are used to protect the mower/aerator user from any injury associated with the spikes.

The guards are constructed from any light, strong, resilient material such as aluminum, steel, or plastic.

Embodiments of the aerator attachment may be attached between the wheels at either the front or the rear of lawn mowers which have side chutes for emitting lawn clippings. Embodiments are attached to the front of mowers which have clipping emitters or clipping baggers on the rear of the mower. The first embodiment aerator attachment is suitable for mowers with accessible vertical portions of the deck between the wheels. Some mowers have flanges or flaps extending between the wheels which obstruct the vertical portion of the deck. The second embodiment aerator attachment is suitable for attachment to the horizontal portion of the deck of these mowers.

It is anticipated that specific models of the various mowers will require slight modifications in the shape of the brackets of the embodiments, in the length of the arms, and in the angles between the plane of the bracket and the sides of the arms. Accordingly, the exact dimensions of the attachment are not crucial.

In some embodiments, the frame, axle, collars, and spikes, are manufactured of any suitable strong, hard, durable material, for example, steel, iron, aluminum. In embodiments the sleeves are made of plastic or aluminum.

In operation the collars rotate freely and the tines pierce and are withdrawn from the soil as the mower moves forward and backward, thereby aerating the soil.

In one embodiment of a first embodiment frame as depicted in FIGS. 2 and 4, the frame is constructed throughout of ¼ inch thick steel plate.

The bracket has a long edge 40 or length of 16 inches and a short edge 41 or width of 2 inches. Bracket holes 29 are centered approximately 3½ inches from the bracket short edges.

The arms have upper long edges 42 and 44 with a length of 7¼ inches and lower edges 43 and 45 with a length of 6¾ inches. The arm ends 46 and 47 are 2 inches in length. Holes 21 and 23 in the arms are centered approximately 2 inches from the ends 46 and 47, respectively. The arms are welded to the bracket.

In this embodiment the axle 30 is constructed of ±2 inch diameter steel rod 16 inches long.

In this embodiment there are 4 collars 34. Each collar is constructed of aluminum and is a cylinder with a length of ¾ inch and has an outer diameter of 2 inches and an inner diameter of approximately ½ inch.

In this embodiment 6 spikes 36 are arrayed at equidistance about the circumference of each collar. Each spike is ¼ inch in diameter, 3¾ inch in length, and penetrates the ground approximately 1½ inch. Each spike is threaded on one end and sharpened on the other end.

This embodiment includes two short sleeves 33 and 35 of 1¼ inch in length and three long sleeves 38 of 3 inch in length. Sleeves are constructed of plastic cylinders. While this example describes the dimensions of one embodiment, other embodiments will have other dimensions. For example, spikes of length 2 inches to 6 inches are contemplated.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

We claim:

1. An aerator attachment for a lawn mower comprising:
a frame comprised of a bracket with means for reversible attachment to the mower, and
two support arms attached to the bracket,
a tine assembly attached to the frame comprising
an axle extending between the support arms,
a multiplicity of sleeves mounted on the axle,
a multiplicity of collars rotatively mounted on the axle, the collars interspersed between the sleeves, and
a multiplicity of tines arrayed about the circumference of the collars.

2. The aerator attachment of claim 1 wherein the frame bracket is approximately vertical when attached to a lawn mower.

3. The frame of claim 2 wherein the angle between the plane of the bracket and the lower edge of the support arms is approximately 45°.

4. The aerator attachment of claim 1 wherein the frame bracket is approximately horizontal when attached to a lawn mower.

5. The frame of claim 4 wherein the angle between the plane of the bracket and the lower edge of the support arms is approximately 135°.

6. An aerator attachment of claim 1 further comprising a guard comprising an approximately hemispheric canopy attached to an approximately rectangular flange, the plane of the flange approximately parallel to a radius to the canopy.

7. An aerator attachment of claim 1 further comprising a guard comprising an approximately hemispheric canopy attached to an approximately rectangular flange, the plane of the flange approximately tangent to the canopy.

8. The aerator attachment of claim 1 wherein the spikes are removable.

9. The aerator attachment of claim 1 wherein the frame arms are integral with the frame bracket.

10. The aerator attachment of claim 1 wherein the frame arms are welded or bolted to the frame bracket.

11. The aerator attachment of claim 1 wherein the aerator is attached to the front or the rear of the mower.

12. The aerator attachment of claim 1 wherein the attachment means are bolts, screws, clamps, hooks, cables, or latches.

13. An aerator attachment for a lawn mower comprising:
a frame comprised of a bracket with bolts for reversible attachment to the mower, and
two support arms welded to the ends of the bracket,
a tine assembly attached to the frame comprising
an axle extending between the support arms,
four collars rotatively mounted on the axle,
a short sleeve mounted on the axle at each end of the axle,
three long sleeves mounted on the axle between the short sleeves,
a collar mounted between each short sleeve and adjacent long sleeve,
a collar mounted between each adjacent long sleeve,
six tines arrayed about the circumference of the collars,
the tines removably mounted to the collars and secured by lock nuts.

14. The aerator attachment of claim 13 further comprising a guard removably attached to the mower.
